(19) United States
(12) Patent Application Publication
(10) Pub. No.: US 2023/0335780 A1
(43) Pub. Date: Oct. 19, 2023

(54) SECONDARY BATTERY, ELECTRONIC EQUIPMENT, AND ELECTRIC TOOL

(71) Applicant: MURATA MANUFACTURING CO., LTD., Kyoto (JP)

(72) Inventor: Akira OTANI, Kyoto (JP)

(21) Appl. No.: 18/211,927

(22) Filed: Jun. 20, 2023

Related U.S. Application Data
(63) Continuation of application No. PCT/JP2021/040362, filed on Nov. 2, 2021.

(30) Foreign Application Priority Data
Jan. 26, 2021 (JP) 2021-010375

(51) Int. Cl. H01M 10/04; H01M 50/538; H01M 50/107; H01M 4/70; H01M 10/0587

(52) U.S. Cl. CPC H01M 10/0431; H01M 50/538; H01M 50/107; H01M 4/70; H01M 10/0587

(57) ABSTRACT

A secondary battery is provided and includes an electrode wound body, a positive electrode current collector, a negative electrode current collector, and a battery can. The electrode wound body includes a positive electrode having a band shape and a negative electrode having a band shape. The positive electrode and the negative electrode are stacked with a separator interposed therebetween. The battery can contains the electrode wound body, the positive electrode current collector, and the negative electrode current collector. The electrode wound body has one or more flat surfaces, in which a positive electrode active material uncovered part, a negative electrode active material uncovered part, or both are bent toward a central axis of a wound structure to form the one or more flat surfaces, and a groove provided in each of the one or more flat surface. As viewed in a section taken along a plane passing through the central axis, a hole part provided in a region where one of the positive electrode active material uncovered part or the negative electrode active material uncovered part is bent has a first diameter and a second diameter that are substantially parallel to a stacking direction, the first diameter is located more toward an inner part of the electrode wound body than the second diameter, and the hole part increases in diameter substantially continuously from the first diameter to the second diameter.

### CROSS REFERENCE TO RELATED APPLICATIONS

The present application is a continuation of PCT patent application no. PCT/JP2021/040362, filed on Nov. 2, 2021, which claims priority to Japanese patent application no. JP2021-010375, filed on Jan. 26, 2021, the entire contents of which are incorporated herein by reference.

### BACKGROUND

The present application relates to a secondary battery, electronic equipment, and an electric tool.

Development of lithium ion batteries has expanded to applications that require high output power, including electric tools and vehicles. One of methods to achieve high output power is high-rate discharging in which a relatively large current is fed from a battery. Because the high-rate discharging involves feeding of a large current, it is desirable to reduce an internal resistance of the battery.

A lithium ion battery having a wound electrode structure is typically structured to have a through hole at a center of an electrode wound body.

For example, a nonaqueous secondary battery is described in which a central through hole is enlarged in diameter. An electrochemical device, or a battery, is described in which an exposed part of a current collector is bent toward a central through hole.

### SUMMARY

The present application relates to a secondary battery, electronic equipment, and an electric tool.

In a technique described in the nonaqueous secondary battery identified in the Background section, what is to be enlarged in diameter is a separator. The separator can peel off when enlarged in diameter. In a technique described in the electrochemical device or battery identified in the Background section, an exposed part of a current collector that is bent can block a through hole, or can unwantedly decrease a diameter of the through hole at a center, making it difficult to insert a welding rod into the through hole.

The present application relates to providing a novel and useful secondary battery that eliminates the above-described inconvenience, and to provide electronic equipment and an electric tool that each include the secondary battery according to an embodiment.

In an embodiment, a secondary battery includes an electrode wound body, a positive electrode current collector, a negative electrode current collector, and a battery can. The electrode wound body includes a positive electrode having a band shape and a negative electrode having a band shape. The positive electrode and the negative electrode are stacked with a separator interposed therebetween. The battery can contains the electrode wound body, the positive electrode current collector, and the negative electrode current collector.

The positive electrode includes, on a positive electrode foil having a band shape, a positive electrode active material covered part covered with a positive electrode active material layer, and a positive electrode active material uncovered part.

The negative electrode includes, on a negative electrode foil having a band shape, a negative electrode active material covered part covered with a negative electrode active material layer, and a negative electrode active material uncovered part extending at least in a longitudinal direction of the negative electrode foil.

The positive electrode active material uncovered part is coupled to the positive electrode current collector at one of end parts of the electrode wound body.

The negative electrode active material uncovered part is coupled to the negative electrode current collector at another of the end parts of the electrode wound body.

The electrode wound body has one or more flat surfaces, in which the positive electrode active material uncovered part, the negative electrode active material uncovered part, or both are bent toward a central axis of a wound structure to form the one or more flat surfaces, and a groove provided in each of the one or more flat surfaces.

As viewed in a section taken along a plane passing through the central axis,
a hole part provided in a region where one of the positive electrode active material uncovered part or the negative electrode active material uncovered part is bent has a first diameter and a second diameter that are substantially parallel to a stacking direction,
the first diameter is located more toward an inner part of the electrode wound body than the second diameter, and
the hole part increases in diameter substantially continuously from the first diameter to the second diameter.

According to an embodiment, it is possible to prevent the occurrence of a defect such as peeling of, for example, the separator located at a peripheral surface of the through hole of the electrode wound body, or difficulty in inserting a welding rod into the through hole. It should be understood that the contents of the present disclosure are not to be construed as being limited by the effects exemplified herein.

### BRIEF DESCRIPTION OF THE FIGURES

FIG. 1 is a sectional view of a lithium ion battery according to an embodiment.

FIG. 2 includes views A and B which are diagrams for describing a positive electrode according to an embodiment.

FIG. 3 includes views A and B which are diagrams for describing a negative electrode according to an embodiment.

FIG. 4 is a diagram illustrating the positive electrode, the negative electrode, and a separator before being wound.

FIG. 5 includes views A and B, where view A is a plan view of a positive electrode current collector according to an embodiment, and view B is a plan view of a negative electrode current collector according to an embodiment.

FIG. 6 includes views A to F which are diagrams describing a process of assembling the lithium ion battery according to an embodiment.

FIG. 7 includes views A and B which are diagrams for describing a configuration example of a groove forming jig according to an embodiment.

FIG. 8 is a partial enlarged view of the groove forming jig according to an embodiment.

FIG. 9 includes views A and B which are diagrams for describing a configuration example of a flat surface forming jig according to an embodiment.

FIG. 10 is a partial, enlarged sectional view of the lithium ion battery according to an embodiment.

FIG. 11 is a diagram for describing density.

FIG. 12 is a diagram for describing Comparative example 1.

FIG. 13 is a diagram for describing Comparative example 2.

FIG. 14 is a coupling diagram for use to describe a battery pack as an application example according to an embodiment.

FIG. 15 is a coupling diagram for use to describe an electric tool as an application example according to an embodiment.

FIG. 16 is a coupling diagram for use to describe an electric vehicle as an application example according to an embodiment.

### DETAILED DESCRIPTION

One or more embodiments of the present disclosure are described below in further detail including with reference to the drawings. The one or more embodiments described herein are examples of the present disclosure, and the contents of the present disclosure are not limited thereto. It is to be noted that in order to facilitate understanding of description, one or more features including components as illustrated in any of the drawings may be enlarged, emphasized, or reduced, or illustration of at least some portions may be simplified.

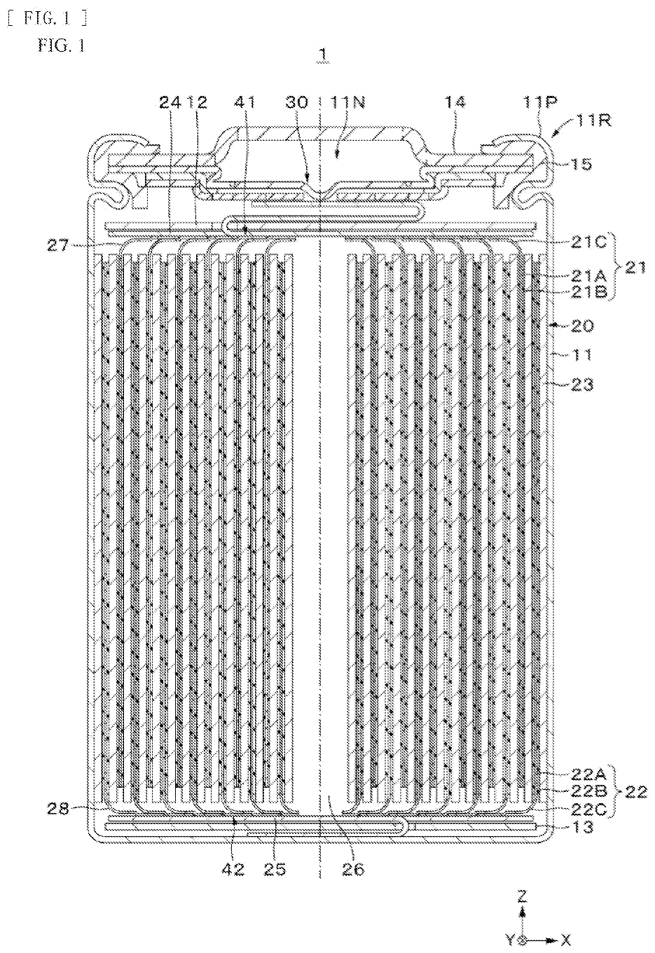

In an embodiment, a lithium ion battery having a cylindrical shape will be described as an example of a secondary battery. A configuration example of the lithium ion battery according to an embodiment, i.e., a lithium ion battery 1, will be described with reference to FIGS. 1 to 5. FIG. 1 is a schematic sectional view of the lithium ion battery 1. As illustrated in FIG. 1, the lithium ion battery 1 has a cylindrical shape and includes an electrode wound body 20 contained inside a battery can 11, for example. In the following description, unless otherwise specified, a horizontal direction in the plane of FIG. 1 will be referred to as an X-axis direction, a direction into the plane of FIG. 1 will be referred to as a Y-axis direction, and a vertical direction, i.e., a direction of extension of a central axis (an axis represented by a dot-and-dash line in FIG. 1) of the lithium ion battery 1 in the plane of FIG. 1 will be referred to as a Z-axis direction, as appropriate. The central axis will also be referred to as a winding axis as appropriate.

In a schematic configuration, the lithium ion battery 1 includes the battery can 11 having a cylindrical shape, and also includes, inside the battery can 11, a pair of insulators 12 and 13 and the electrode wound body 20. Note that the lithium ion battery 1 may further include, for example, one or more of devices and members including, without limitation, a thermosensitive resistive device or a PTC device and a reinforcing member, inside the battery can 11.

The battery can 11 is a member that contains mainly the electrode wound body 20. The battery can 11 is, for example, a cylindrical container with one end face open and another end face closed. That is, the battery can 11 has one open end face (an open end face 11N). The battery can 11 includes, for example, one or more of metal materials including, without limitation, iron, aluminum, and alloys thereof. The battery can 11 may have a surface plated with one or more of metal materials including, without limitation, nickel, for example.

The insulators 12 and 13 are disk-shaped plates each having a surface that is substantially perpendicular to a central axis of the electrode wound body 20. The central axis passes through substantially a center of an end face of the electrode wound body 20 and is in a direction parallel to the Z-axis in FIG. 1. The insulators 12 and 13 are so disposed as to allow the electrode wound body 20 to be interposed therebetween, for example.

A battery cover 14 and a safety valve mechanism 30 are crimped to the open end face 11N of the battery can 11 via a gasket 15 to thereby provide a crimped structure 11R (a crimp structure). The battery can 11 is thus sealed, with the electrode wound body 20 and other components being contained inside the battery can 11.

The battery cover 14 is a member that closes the open end face 11N of the battery can 11 mainly in the state where the electrode wound body 20 and the other components are contained inside the battery can 11. The battery cover 14 includes, for example, a material similar to the material included in the battery can 11. A middle region of the battery cover 14 protrudes in a +Z direction, for example. A region other than the middle region, that is, a peripheral region, of the battery cover 14 is thus in contact with the safety valve mechanism 30, for example.

The gasket 15 is a member that is mainly interposed between the battery can 11 (a bent part 11P) and the battery cover 14 to thereby seal a gap between the bent part 11P and the battery cover 14. Note that the gasket 15 may have a surface coated with a material such as asphalt, for example.

The gasket 15 includes one or more of insulating materials, for example. The insulating material is not particularly limited in kind. For example, a polymer material such as polybutylene terephthalate (PBT) or polypropylene (PP) may be used as the insulating material. In particular, the insulating material is preferably polybutylene terephthalate. A reason for this is that such a material is able to sufficiently seal the gap between the bent part 11P and the battery cover 14 while electrically separating the battery can 11 and the battery cover 14 from each other.

The safety valve mechanism 30 cancels the sealed state of the battery can 11 and thereby releases a pressure inside the battery can 11, i.e., an internal pressure of the battery can 11 on an as-needed basis, mainly upon an increase in the internal pressure. Examples of a cause of the increase in the internal pressure of the battery can 11 include a gas generated due to a decomposition reaction of an electrolytic solution during charging and discharging.

In the lithium ion battery 1 having a cylindrical shape, a positive electrode 21 having a band shape and a negative electrode 22 having a band shape, which are stacked with a separator 23 interposed therebetween and are wound in a spiral shape, are contained in the battery can 11, being impregnated with the electrolytic solution. The positive electrode 21 includes a positive electrode foil 21A with a positive electrode active material layer 21B provided on one of or each of both surfaces of the positive electrode foil 21A. A material of the positive electrode foil 21A is a metal foil including, for example, aluminum or an aluminum alloy. The negative electrode 22 includes a negative electrode foil 22A with a negative electrode active material layer 22B provided on one of or each of both surfaces of the negative electrode foil 22A. A material of the negative electrode foil 22A is a metal foil including, for example, nickel, a nickel alloy, copper, or a copper alloy. The separator 23 is a porous insulating film. The separator 23 electrically insulates the positive electrode 21 and the negative electrode 22 from each other, and allows for movement of substances including, without limitation, ions and the electrolytic solution.

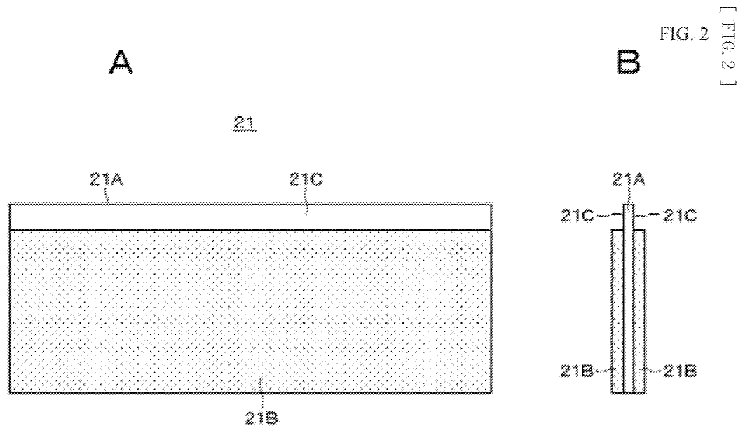

FIG. 2, view A is a front view of the positive electrode 21 before being wound. FIG. 2, view B is a side view of the positive electrode 21 of FIG. 2, view A. The positive electrode 21 includes, at each of one major surface and another major surface of the positive electrode foil 21A, a part (a part shaded with dots) covered with the positive electrode active material layer 21B, and a positive electrode active material uncovered part 21C which is a part not covered with the positive electrode active material layer 21B. Note that in the following description, the part covered with the positive electrode active material layer 21B will be referred to as a positive electrode active material covered part 21B as appropriate. The positive electrode 21 may have a configuration in which the positive electrode active material covered part 21B is provided at one of the major surfaces of the positive electrode foil 21A.

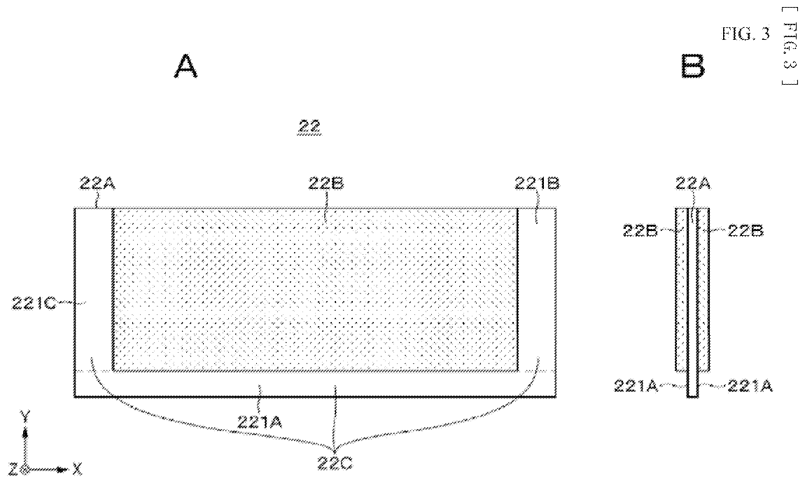

FIG. 3, view A is a front view of the negative electrode 22 before being wound. FIG. 3, view B is a side view of the negative electrode 22 of FIG. 3, view A. The negative electrode 22 includes, at each of one major surface and another major surface of the negative electrode foil 22A, a part (a part shaded with dots) covered with the negative electrode active material layer 22B, and a negative electrode active material uncovered part 22C which is a part not covered with the negative electrode active material layer 22B. Note that in the following description, the part covered with the negative electrode active material layer 22B will be referred to as a negative electrode active material covered part 22B as appropriate. The negative electrode 22 may have a configuration in which the negative electrode active material covered part 22B is provided at one of the major surfaces of the negative electrode foil 22A.

As illustrated in FIG. 3, view A, the negative electrode active material uncovered part 22C includes, for example, a first negative electrode active material uncovered part 221A, a second negative electrode active material uncovered part 221B, and a third negative electrode active material uncovered part 221C. The first negative electrode active material uncovered part 221A extends in a longitudinal direction of the negative electrode 22, i.e., in the X-axis direction in FIG. 3. The second negative electrode active material uncovered part 221B is provided on a beginning side of winding of the negative electrode 22 and extends in a transverse direction of the negative electrode 22, i.e., in the Y-axis direction in FIG. 3, which will also be referred to as a width direction as appropriate. The third negative electrode active material uncovered part 221C is provided on an end side of the winding of the negative electrode 22 and extends in the transverse direction of the negative electrode 22, i.e., in the Y-axis direction in FIG. 3. Note that in FIG. 3, view A, a boundary between the first negative electrode active material uncovered part 221A and the second negative electrode active material uncovered part 221B, and a boundary between the first negative electrode active material uncovered part 221A and the third negative electrode active material uncovered part 221C are each represented by a dashed line.

In the electrode wound body 20 of the lithium ion battery 1 having the cylindrical shape according to the present embodiment, the positive electrode 21 and the negative electrode 22 are laid over each other and wound, with the separator 23 interposed therebetween, in such a manner that the positive electrode active material uncovered part 21C and the first negative electrode active material uncovered part 221A face toward opposite directions.

The electrode wound body 20 has a through hole 26 in a region including the central axis of the electrode wound body 20. Specifically, the through hole 26 is a hole part that develops at substantially a center of a stack in which the positive electrode 21, the negative electrode 22, and the separator 23 are stacked. The through hole 26 is used as a hole into which a rod-shaped welding tool, which will hereinafter be referred to as a welding rod, as appropriate, is to be inserted in a process of assembling the lithium ion battery 1.

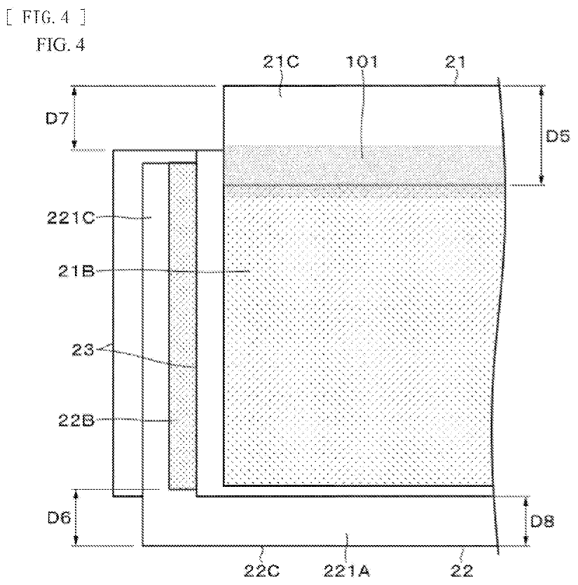

Details of the electrode wound body 20 will be described. FIG. 4 illustrates an example of a pre-winding structure in which the positive electrode 21, the negative electrode 22, and the separator 23 are stacked. The positive electrode 21 further includes an insulating layer 101 (a gray region part in FIG. 4) covering a boundary between the positive electrode active material covered part 21B (a part lightly shaded with dots in FIG. 4) and the positive electrode active material uncovered part 21C. The insulating layer 101 has a length in the width direction of about 3 mm, for example. All of a region of the positive electrode active material uncovered part 21C opposed to the negative electrode active material covered part 22B with the separator 23 interposed therebetween is covered with the insulating layer 101. The insulating layer 101 has an effect of reliably preventing an internal short circuit of the lithium ion battery 1 when foreign matter enters between the negative electrode active material covered part 22B and the positive electrode active material uncovered part 21C. In addition, the insulating layer 101 has an effect of, in a case where the lithium ion battery 1 undergoes an impact, absorbing the impact and thereby reliably preventing the positive electrode active material uncovered part 21C from bending and short-circuiting with the negative electrode 22.

Here, as illustrated in FIG. 4, a length of the positive electrode active material uncovered part 21C in the width direction is denoted as D5, and a length of the first negative electrode active material uncovered part 221A in the width direction is denoted as D6. In an embodiment, it is preferable that D5>D6. For example, D5=7 (mm), and D6=4 (mm). Where a length of a portion of the positive electrode active material uncovered part 21C protruding from one end in the width direction of the separator 23 is denoted as D7 and a length of a portion of the first negative electrode active material uncovered part 221A protruding from another end in the width direction of the separator 23 is denoted as D8, in an embodiment, it is preferable that D7>D8. For example, D7=4.5 (mm), and D8=3 (mm).

The positive electrode foil 21A and the positive electrode active material uncovered part 21C include aluminum, for example. The negative electrode foil 22A and the negative electrode active material uncovered part 22C include copper, for example. Thus, the positive electrode active material uncovered part 21C is typically softer, that is, lower in Young's modulus, than the negative electrode active material uncovered part 22C. Accordingly, in an embodiment, it is more preferable that D5>D6 and D7>D8. In such a case, when portions of the positive electrode active material uncovered part 21C and portions of the negative electrode active material uncovered part 22C are simultaneously bent with equal pressures from both electrode sides, respective heights of the bent portions as measured from respective ends of the separator 23 may be substantially the same between the positive electrode 21 and the negative electrode 22. In this situation, the portions of the positive electrode active material uncovered part 21C appropriately overlap with each other when bent, which makes it possible to easily couple the positive electrode active material uncovered part 21C and a positive electrode current collector 24 to each other by laser welding in a process of fabricating the lithium ion battery 1. Further, the portions of the negative electrode active material uncovered part 22C appropriately overlap with each other when bent, which makes it possible to easily couple the negative electrode active material uncovered part 22C and a negative electrode current collector 25 to each other by laser welding in the process of fabricating the lithium ion battery 1. Details of the process of fabricating the lithium ion battery 1 will be described later.

In a typical lithium ion battery, for example, a lead for current extraction is welded at one location on each of the positive electrode and the negative electrode. However, such a configuration is not suitable for high-rate discharging because a high internal resistance of the battery results to cause the lithium ion battery to generate heat and become hot during discharging. To address this, in the lithium ion battery 1 according to the present embodiment, the positive electrode current collector 24 is disposed on one end face, i.e., an end face 41, of the electrode wound body 20, and the negative electrode current collector 25 is disposed on another end face, i.e., an end face 42, of the electrode wound body 20. In addition, the positive electrode current collector 24 and the positive electrode active material uncovered part 21C located at the end face 41 are welded to each other at multiple points; and the negative electrode current collector 25 and the negative electrode active material uncovered part 22C (specifically, the first negative electrode active material uncovered part 221A) located at the end face 42 are welded to each other at multiple points. The internal resistance of the lithium ion battery 1 is thereby kept low to allow for high-rate discharging.

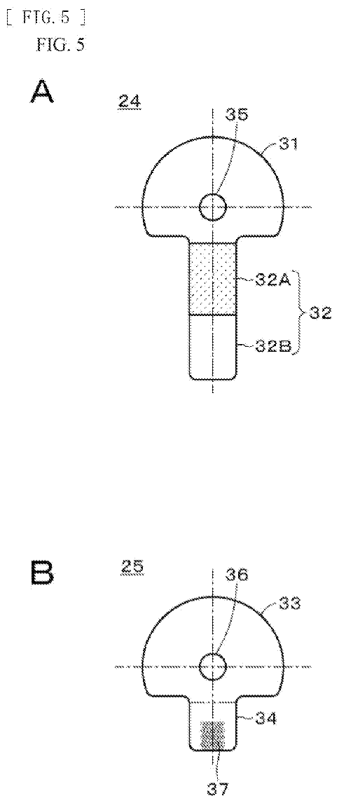

FIG. 5, views A and B illustrate respective examples of the current collectors. FIG. 5, view A illustrates the positive electrode current collector 24. FIG. 5, view B illustrates the negative electrode current collector 25. The positive electrode current collector 24 and the negative electrode current collector 25 are contained in the battery can 11 (see FIG. 1). A material of the positive electrode current collector 24 is a metal plate including, for example, a simple substance or a composite material of aluminum or an aluminum alloy. A material of the negative electrode current collector 25 is a metal plate including, for example, a simple substance or a composite material of nickel, a nickel alloy, copper, or a copper alloy. As illustrated in FIG. 5A, the positive electrode current collector 24 has a shape in which a band-shaped part 32 having a rectangular shape is attached to a fan-shaped part 31 having a flat fan shape. The fan-shaped part 31 has a hole 35 at a position near a middle thereof. The position of the hole 35 corresponds to a position of the through hole 26 and a position of a hole part (a hole part 73) to be described later.

A part shaded with dots in FIG. 5A represents an insulating part 32A in which an insulating tape or an insulating material is attached or applied to the band-shaped part 32. A part below the dot-shaded part in FIG. 5, view A represents a coupling part 32B to be coupled to a sealing plate that also serves as an external terminal. Note that in a case of a battery structure having no metallic center pin (not illustrated) in the through hole 26, the insulating part 32A may be omitted because there is a low possibility of contact of the band-shaped part 32 with a region of a negative electrode potential. In such a case, it is possible to increase charge and discharge capacities by increasing a width of each of the positive electrode 21 and the negative electrode 22 by an amount corresponding to a thickness of the insulating part 32A.

The negative electrode current collector 25 is similar to the positive electrode current collector 24 in shape, but has a band-shaped part of a different shape. The band-shaped part 34 of the negative electrode current collector of FIG. 5, view B is shorter than the band-shaped part 32 of the positive electrode current collector 24 and includes no portion corresponding to the insulating part 32A. The band-shaped part 34 is provided with circular projections 37 depicted as multiple circles. Upon resistance welding, current is concentrated on the projections 37, causing the projections 37 to melt to thereby cause the band-shaped part 34 to be welded to a bottom of the battery can 11. As with the positive electrode current collector 24, the negative electrode current collector 25 has a hole 36 at a position near a middle of a fan-shaped part 33. The position of the hole 36 corresponds to the position of the through hole 26. The fan-shaped part 31 of the positive electrode current collector 24 and the fan-shaped part 33 of the negative electrode current collector 25, which are each in the shape of a fan, cover respective portions of the end faces 41 and 42. By not covering all of the respective end faces 41 and 42, it is possible to allow the electrolytic solution to smoothly permeate the electrode wound body 20 in assembling the lithium ion battery 1, and it is also possible to facilitate releasing of a gas, which is generated when the lithium ion battery 1 comes into an abnormally hot state or an overcharged state, to the outside of the lithium ion battery 1.

The positive electrode active material layer 21B includes at least a positive electrode material (a positive electrode active material) into which lithium is insertable and from which lithium is extractable, and may further include, for example, a positive electrode binder and a positive electrode conductor. The positive electrode material is preferably a lithium-containing composite oxide or a lithium-containing phosphoric acid compound. The lithium-containing composite oxide has a layered rock-salt crystal structure or a spinel crystal structure, for example. The lithium-containing phosphoric acid compound has an olivine crystal structure, for example.

The positive electrode binder includes a synthetic rubber or a polymer compound. Examples of the synthetic rubber include a styrene-butadiene-based rubber, a fluorine-based rubber, and ethylene propylene diene. Examples of the polymer compound include polyvinylidene difluoride (PVdF) and polyimide.

The positive electrode conductor is a carbon material such as graphite, carbon black, acetylene black, or Ketjen black. Note that the positive electrode conductor may be a metal material or an electrically conductive polymer.

The negative electrode foil 22A configuring the negative electrode 22 is preferably roughened at its surface to achieve improved adherence to the negative electrode active material layer 22B. The negative electrode active material layer 22B includes at least a negative electrode material (a negative electrode active material) into which lithium is insertable and from which lithium is extractable, and may further include, for example, a negative electrode binder and a negative electrode conductor.

The negative electrode material includes a carbon material, for example. The carbon material is graphitizable carbon, non-graphitizable carbon, graphite, low-crystalline carbon, or amorphous carbon. The carbon material has a fibrous shape, a spherical shape, a granular shape, or a flaky shape.

Further, the negative electrode material includes a metal-based material, for example. Examples of the metal-based material include Li (lithium), Si (silicon), Sn (tin), Al (aluminum), Zr (zinc), and Ti (titanium). A metallic element forms a compound, a mixture, or an alloy with another element, and examples thereof include silicon oxide (SiOₓ (0<x≤2)), silicon carbide (SiC), an alloy of carbon and silicon, and lithium titanium oxide (LTO).

The separator 23 is a porous film including a resin, and may be a stacked film including two or more kinds of porous films. Examples of the resin include polypropylene and polyethylene. With the porous film as a base layer, the separator 23 may include a resin layer provided on one of or each of both surfaces of the base layer. A reason for this is that this improves adherence of the separator 23 to each of the positive electrode 21 and the negative electrode 22 and thus suppresses distortion of the electrode wound body 20.

The resin layer includes a resin such as PVdF. In a case of forming the resin layer, a solution including an organic solvent and the resin dissolved therein is applied on the base layer, following which the base layer is dried. Note that the base layer may be immersed in the solution and thereafter the base layer may be dried. From the viewpoint of improving heat resistance and battery safety, the resin layer preferably includes inorganic particles or organic particles. Examples of the kind of the inorganic particles include aluminum oxide, aluminum nitride, aluminum hydroxide, magnesium hydroxide, boehmite, talc, silica, and mica. Alternatively, a surface layer including inorganic particles as a main component and formed by a method such as a sputtering method or an atomic layer deposition (ALD) method may be used instead of the resin layer.

The electrolytic solution includes a solvent and an electrolyte salt, and may further include other materials such as additives on an as-needed basis. The solvent is a nonaqueous solvent such as an organic solvent, or water. The electrolytic solution including a nonaqueous solvent is called a nonaqueous electrolytic solution. Examples of the nonaqueous solvent include a cyclic carbonic acid ester, a chain carbonic acid ester, a lactone, a chain carboxylic acid ester, and a nitrile (mononitrile).

Although a typical example of the electrolyte salt is a lithium salt, the electrolyte salt may include any salt other than the lithium salt. Examples of the lithium salt include lithium hexafluorophosphate (LiPF₆), lithium tetrafluoroborate (LiBF₄), lithium perchlorate (LiClO₄), lithium methanesulfonate (LiCH₃SO₃), lithium trifluoromethanesulfonate (LiCF₃SO₃), and dilithium hexafluorosilicate (Li₂SF₆). These salts may also be used in mixture with each other. From the viewpoint of improving a battery characteristic, it is preferable to use a mixture of LiPF₆ and LiBF₄, in particular. Although not particularly limited, a content of the electrolyte salt is preferably in a range from 0.3 mol/kg to 3 mol/kg both inclusive with respect to the solvent.

Note that in the present specification, unless distinction between the positive electrode and the negative electrode is necessary, the term “positive electrode” and “negative electrode” may be omitted from names of components. For example, when simply referred to as an active material uncovered part, the active material uncovered part may be either the positive electrode active material uncovered part 21C or the first negative electrode active material uncovered part 221A. Further, when simply referred to as a current collector, the current collector may be either the positive electrode current collector 24 or the negative electrode current collector 25. Note, however, that a component on the positive electrode side is to be construed as corresponding to a component on the positive electrode side, and a component on the negative electrode side is to be construed as corresponding to a component on the negative electrode side.

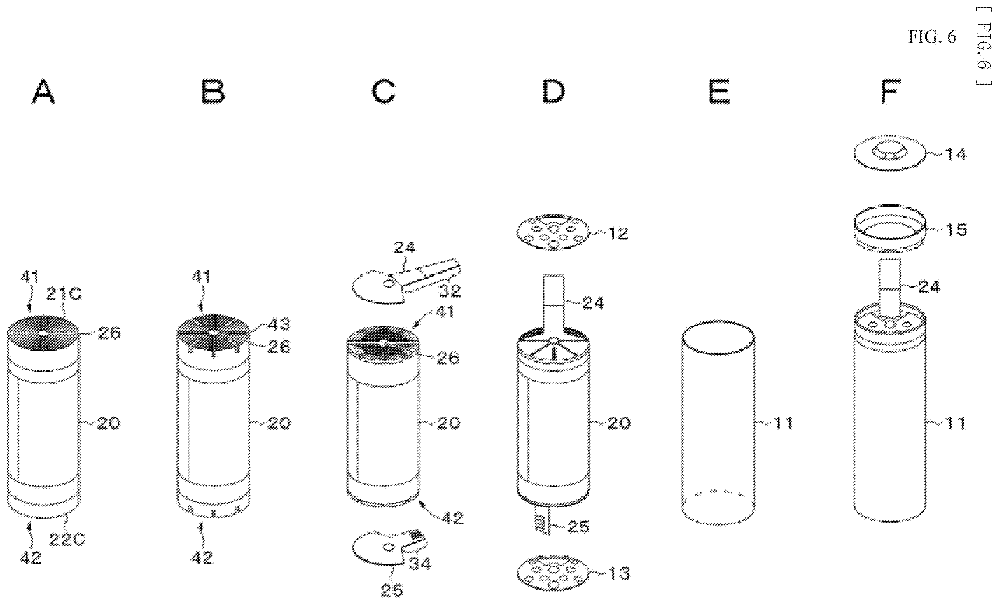

Next, a method of fabricating the lithium ion battery 1 according to an embodiment will be described with reference to FIG. 6, views A to F. First, the positive electrode active material was applied on the surface of the positive electrode foil 21A having a band shape to thereby form the positive electrode active material covered part 21B, and the negative electrode active material was applied on the surface of the negative electrode foil 22A having a band shape to thereby form the negative electrode active material covered part 22B. At this time, the positive electrode active material uncovered part 21C without the positive electrode active material applied thereon was provided on one end side in the width direction of the positive electrode foil 21A, and the negative electrode foil 22A was provided with the negative electrode active material uncovered part 22C (including the first negative electrode active material uncovered part 221A, the second negative electrode active material uncovered part 221B, and the third negative electrode active material uncovered part 221C) without the negative electrode active material applied thereon. Next, the positive electrode 21 and the negative electrode 22 were subjected to processes including a drying process. Thereafter, the positive electrode 21 and the negative electrode 22 were laid over each other with the separator 23 interposed therebetween in such a manner that the positive electrode active material uncovered part 21C and the negative electrode active material uncovered part 22C faced toward opposite directions, and they were wound in a spiral shape to allow the through hole 26 to develop on the central axis. Thus, the electrode wound body 20 as illustrated in FIG. 6, view A was fabricated.

Next, grooves 43 were formed (produced) as illustrated in FIG. 6, view B, using a groove forming jig (a groove forming jig 51 to be described later). Specifically, an end face (an end face 53 to be described later) of the groove forming jig 51 was pressed perpendicularly against each of the end faces 41 and 42 to thereby produce the grooves 43 in a portion of each of the end faces 41 and 42. By this method, the grooves 43 were produced to extend radially from the through hole 26. For example, the grooves 43 extend from an outer edge part of each of the end faces 41 and 42 to the through hole 26. Note that the number and arrangement of the grooves 43 illustrated in FIG. 6, view B are merely one example, and the illustrated example is thus non-limiting.

Thereafter, flat surfaces were formed as illustrated in FIG. 6, view C, using a flat surface forming jig (a flat surface forming jig 61 to be described later). Specifically, respective end faces (end faces 63 to be described later) of the flat surface forming jigs 61 were pressed substantially perpendicularly against the end faces 41 and 42 with equal pressures from both electrode sides simultaneously to thereby apply loads thereto. The positive electrode active material uncovered part 21C and the negative electrode active material uncovered part 22C (more specifically, the first negative electrode active material uncovered part 221A) were thereby bent in such a manner that portions of the positive electrode active material uncovered part 21C were bent toward the central axis of a wound structure and overlapped with each other to make the end face 41 into a flat surface, and that portions of the negative electrode active material uncovered part 22C (more specifically, portions of the first negative electrode active material uncovered part 221A) were bent toward the central axis of the wound structure and overlapped with each other to make the end face 42 into a flat surface. Thereafter, the fan-shaped part 31 of the positive electrode current collector 24 was coupled to the end face 41 by laser welding, and the fan-shaped part 33 of the negative electrode current collector 25 was coupled to the end face 42 by laser welding.

Thereafter, as illustrated in FIG. 6, view D, the band-shaped part 32 of the positive electrode current collector 24 and the band-shaped part 34 of the negative electrode current collector 25 were bent, the insulator 12 was attached to the positive electrode current collector 24, and the insulator 13 was attached to the negative electrode current collector 25. The electrode wound body 20 having been assembled in the above-described manner was placed into the battery can 11 illustrated in FIG. 6, view E. Thereafter, the negative electrode current collector 25 was welded to the bottom of the battery can 11 by pressing the unillustrated welding rod thereagainst. The electrolytic solution was injected into the battery can 11, following which the battery can 11 was sealed with the gasket 15 and the battery cover 14, as illustrated in FIG. 6, view F. The lithium ion battery 1 was fabricated as described above.

Note that the insulators 12 and 13 may each be an insulating tape. Further, a method of coupling may be other than laser welding. The grooves 43 remain in the flat surfaces even after the positive electrode active material uncovered part 21C and the first negative electrode active material uncovered part 221A are bent, and a portion of each of the flat surfaces without the grooves 43 is coupled to the positive electrode current collector 24 or the negative electrode current collector 25; however, the grooves 43 may be coupled to a portion of the positive electrode current collector 24 or a portion of the negative electrode current collector 25.

As used herein, the term “flat surface” encompasses not only a completely flat surface but also a surface having some asperities or surface roughness to the extent that it is possible to couple the positive electrode active material uncovered part 21C and the positive electrode current collector 24 to each other and to couple the first negative electrode active material uncovered part 221A and the negative electrode current collector 25 to each other.

In fabricating the lithium ion battery 1 by the above-described method, it is necessary to insert the welding rod into the through hole 26 in order to weld the negative electrode current collector 25 and the bottom of the battery can 11 to each other. Accordingly, the through hole 26 should not be blocked in a process before a process of inserting the welding rod. In order to improve easiness of positioning and prevent the through hole 26 from being blocked in a groove forming process of forming the grooves 43, a rod-shaped pin to be inserted into the through hole 26 is provided in the vicinity of a middle of the end face of the groove forming jig 51. Similarly, in order to prevent the through hole 26 from being blocked by the bent portions of the positive electrode active material uncovered part 21C or the bent portions of the first negative electrode active material uncovered part 221A in a flat surface forming process of forming the flat surfaces, a rod-shaped pin to be inserted into the through hole 26 is also provided in the vicinity of a middle of the end face of the flat surface forming jig 61.

In a case of employing such a configuration, it is necessary to suitably size a diameter of the pin. That is, if the pin is too large in diameter, the separator located on a side of an innermost wind, i.e., the separator that forms a peripheral surface of the through hole 26, can be peeled or damaged by the pin. There is a further possibility that the negative electrode active material covered part, for example, can be exposed in the peripheral surface, causing the resulting lithium ion battery 1 to be defective. On the contrary, if the pin is too small in diameter, the pin can get caught between the bent portions of the positive electrode active material uncovered part 21C or the first negative electrode active material uncovered part 221A and become difficult to remove. There is a further possibility that it can become difficult to insert the welding rod into the through hole 26 in a subsequent process. In view of these, in the present embodiment, the groove forming jig and the flat surface forming jig are each provided with a suitable shape.

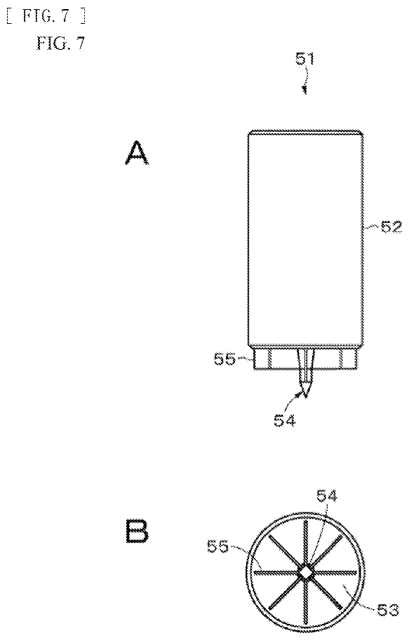

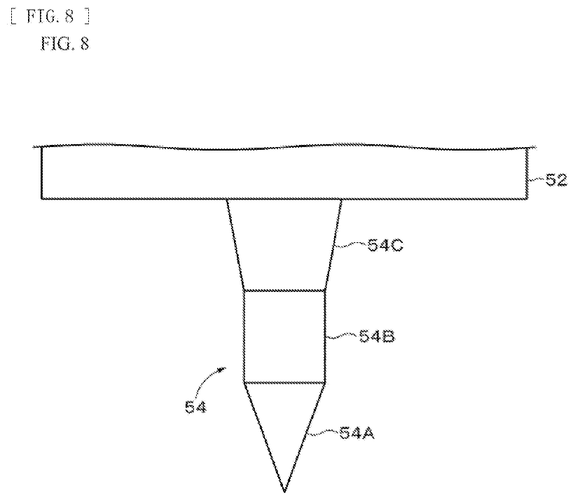

FIG. 7, views A and B, and FIG. 8 are diagrams for describing a configuration example of the groove forming jig 51. Specifically, FIG. 7, view A is a front view of the groove forming jig 51, and FIG. 7, view B is a diagram illustrating a configuration example of one end face, i.e., the end face 53, of the groove forming jig 51.

As illustrated in FIG. 7, view A, the groove forming jig 51 has a body part 52 having a substantially cylindrical shape. As illustrated in FIG. 7, view B, the body part 52 has the end face 53. A pin 54 projects from substantially the middle of the end face 53. Further, a plate-shaped part 55 having a thin plate shape is provided on the end face 53. In the present embodiment, the plate-shaped part 55 includes eight plate-shaped parts that extend radially about the pin 54.

FIG. 8 is a diagram in which the pin 54 is illustrated in an enlarged manner. Note that FIG. 8 omits the illustration of the plate-shaped part 55. The pin 54 has a sharp-pointed part 54A having a substantially triangular pyramid shape in which a tip side (a side opposite to the body part 52) is sharply pointed. An intermediate part 54B having a substantially cylindrical shape is provided on a circular bottom surface of the sharp-pointed part 54A. The intermediate part 54B has a substantially constant diameter. A tapered part 54C having a substantially frustoconical shape is provided on one end side (a side opposite to the sharp-pointed part 54A) of the intermediate part 54B. The tapered part 54C increases in diameter toward the body part 52. The circular bottom surface of the sharp-pointed part 54A and the intermediate part 54B each have a diameter slightly smaller than a diameter of the through hole 26. For example, the sharp-pointed part 54A, the intermediate part 54B, and the tapered part 54C include a material such as a resin or a metal, and are integrally formed; however, these three parts may be separate parts that are combined by a method such as bonding.

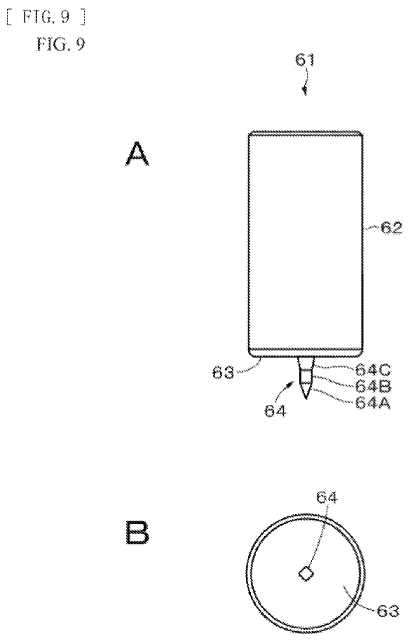

FIG. 9 is a diagram for describing a configuration example of the flat surface forming jig 61. FIG. 9, view A is a front view of the flat surface forming jig 61, and FIG. 9, view B is a diagram illustrating a configuration example of one end face, i.e., the end face 63, of the flat surface forming jig 61.

As illustrated in FIG. 9, view A, the flat surface forming jig 61 has a body part 62 having a substantially cylindrical shape. The body part 62 has the end face 63. As illustrated in FIG. 9, view B, a pin 64 projects from substantially the middle of the end face 63. The end face 63 excluding the pin 64 is flat. The pin 64 has substantially the same shape as the pin 54. That is, the pin 64 includes a sharp-pointed part 64A, an intermediate part 64B, and a tapered part 64C. A substantially circular bottom surface of the sharp-pointed part 64A and the intermediate part 64B each have a diameter slightly smaller than the diameter of the through hole 26. For example, the sharp-pointed part 64A, the intermediate part 64B, and the tapered part 64C include a material such as a resin or a metal, and are integrally formed; however, these three parts may be separate parts that are combined by a method such as bonding.

A description will be given of respective workings of the groove forming jig 51 and the flat surface forming jig 61. The groove forming jig 51 is used in the groove forming process (see FIG. 6, view B) of forming the grooves 43. For example, positioning of the groove forming jig 51 is effected by inserting the pin 54 of the groove forming jig 51 into a portion in the vicinity of a position immediately above the through hole 26 on the end face 41 side, that is, into a hole part formed by the positive electrode active material uncovered part 21C before being bent. The groove forming jig 51 in the positioned state is pressed into the electrode wound body 20 to thereby form the eight grooves 43 in the end face 41. A similar process is performed also on the end face 42. The groove forming process may be performed on the two end faces 41 and 42 simultaneously. Because the pin 54 is inserted into the through hole 26 upon pressing, it is possible to prevent the through hole 26 from being blocked in the course of forming the grooves 43.

The flat surface forming jig 61 is used in the flat surface forming process (see FIG. 6, view C). For example, positioning of the flat surface forming jig 61 is effected by inserting the pin 64 of the flat surface forming jig 61 into the portion in the vicinity of the position immediately above the through hole 26 on the end face 41 side. The flat surface forming jig 61 in the positioned state is pressed into the electrode wound body 20 to thereby bend portions of the positive electrode active material uncovered part 21C to make the end face 41 flat. The flat surface is thus formed. A similar process is performed also on the end face 42. The flat surface forming process may be performed on the two end faces 41 and 42 simultaneously. Because the pin 64 is inserted into the through hole 26 upon pressing, it is possible to prevent the through hole 26 from being blocked by the bent portions of the positive electrode active material uncovered part 21C or the bent portions of the first negative electrode active material uncovered part 221A in the course of forming the flat surface. Note that the groove forming process and the flat surface forming process described above may be performed either manually or automatically with a predetermined device.

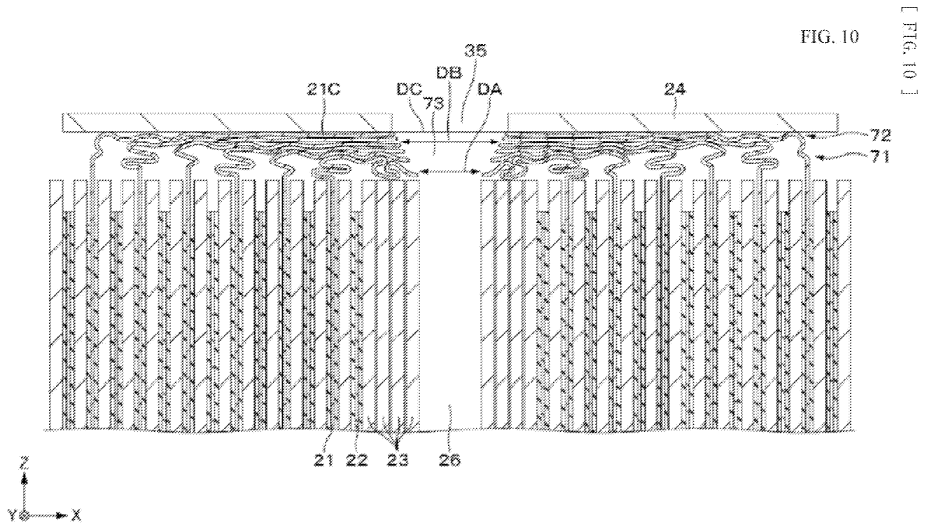

FIG. 10 illustrates a section of the fabricated lithium ion battery 1 taken along a plane passing through the central axis, that is, a section taken at a location where the end faces 41 and 42 of the electrode wound body 20 have no grooves 43. Note that although FIG. 10 is a diagram illustrating a positive electrode 21 side, the following description similarly applies to a negative electrode 22 side. In addition, for convenience, FIG. 10 omits the illustration of the safety valve mechanism 30, for example.

The peripheral surface of the through hole 26 is, for example, the separator 23, and a portion of the electrode wound body 20 on an inner wind side is configured by four layers of the separator 23 stacked along a stacking direction, i.e., the X-axis direction in FIG. 10. The positive electrode active material uncovered part 21C bent in the flat surface forming process forms a bent part 71. An outer surface of the bent part 71 forms a flat surface 72. The positive electrode current collector 24 is welded to the flat surface 72.

In the groove forming process and the flat surface forming process, respective portions of the pins 54 and 64 are inserted into the through hole 26, and respective other portions of the pins 54 and 64 are located immediately above the through hole 26. This prevents the through hole 26 from being blocked in each process, and furthermore, allows for formation of the hole part 73 in the bent part 71, which is a region where positive electrode active material uncovered part 21C is bent. The through hole 26 and the hole part 73 communicate with each other. The hole part 73 further communicates with the hole 35 of the positive electrode current collector 24.

Specifically, upon insertion of the pin 54, the sharp-pointed part 54A of the pin 54 is located in the through hole 26, the intermediate part 54B is located across a boundary between the through hole 26 and the hole part 73, and the tapered part 54C is located closer to an upper side of the hole part 73. Further, upon insertion of the pin 64, the sharp-pointed part 64A of the pin 64 is located in the through hole 26, the intermediate part 64B is located across the boundary between the through hole 26 and the hole part 73, and the tapered part 64C is located closer to the upper side of the hole part 73. Accordingly, when the lithium ion battery 1 is viewed in the section as illustrated in FIG. 10, the hole part 73 has a shape corresponding to the tapered part 54C or 64C, that is, increases in width from an inner side toward an outer side.

Here, in the sectional view as illustrated in FIG. 10, the hole part 73 has a first diameter DA which is substantially parallel to the stacking direction, i.e., the X-axis direction, and a second diameter DB at a predetermined distance or more from the first diameter DA. The first diameter DA is located more toward an inner part of the electrode wound body 20 than the second diameter DB. Because the hole part 73 has a tapered shape as described above, its diameter increases substantially continuously from the first diameter DA to the second diameter DB. Here, the phrase “substantially continuously” is intended to mean that, in the course of changing from the first diameter DA to the second diameter DB, the diameter may partly decrease due to protrusion of a portion of the positive electrode active material uncovered part 21C toward the central axis.

Here, as illustrated in FIG. 10, a straight line that couples points on a bottom surface of the positive electrode current collector 24 coupled to the bent part 71 is defined as a reference line DC. The first diameter DA described above is a diameter that is smallest over a distance range of 0.5 to 1.5 mm from the reference line DC toward the inner part of the electrode wound body 20, that is, a range in the vicinity of an open end of the through hole 26 in the lithium ion battery 1 according to the present embodiment. The second diameter DB is a diameter that is smallest over a distance range of 0 to 0.2 mm from the reference line DC toward the inner part of the electrode wound body 20. Note that in a case of 0 mm, the second diameter DB and the reference line DC coincide with each other. Although some small error can result from the bent part 71 in which portions of the positive electrode active material uncovered part 21C are not uniformly stacked, the first diameter DA is substantially equal to a maximum diameter of each of the sharp-pointed parts 54A and 64A or the diameter of each of the intermediate parts 54B and 64B, and the second diameter DB is substantially equal to a maximum diameter of each of the tapered parts 54C and 64C.

Note that a size, at the reference line DC, of a region corresponding to the hole 35 that the positive electrode current collector 24 has, that is, a size corresponding to a diameter of the hole 35, is preferably greater than the first diameter DA and the second diameter DB. This helps to ensure that the positive electrode current collector 24 comes into contact with the flat surface 72 even if the bent portions of the positive electrode active material uncovered part 21C are slightly misaligned, thus helping to prevent the occurrence of a welding defect.

In the lithium ion battery 1 according to the present embodiment, as viewed in the section described above, the active material uncovered part is present in a higher density in a region adjacent to an inner peripheral part of the current collector than in a region adjacent to an outer peripheral part of the current collector.

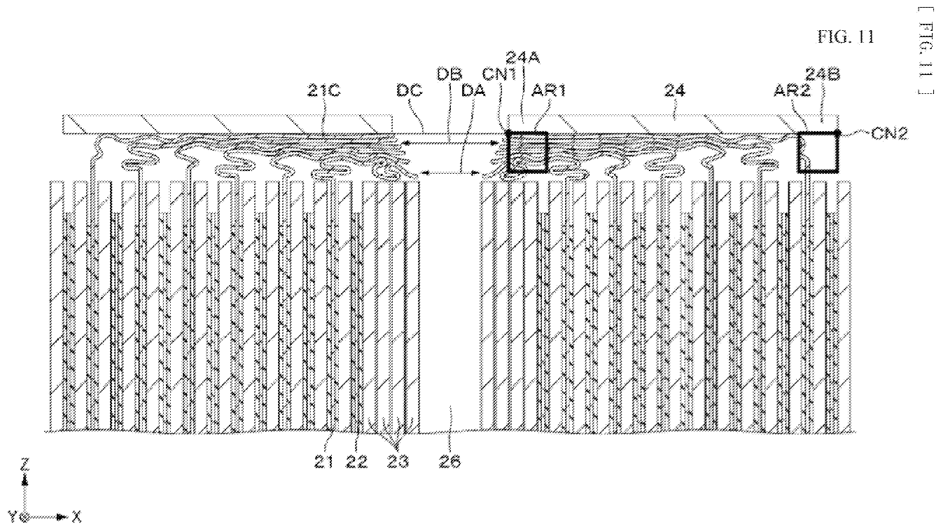

For example, as illustrated in FIG. 11, a region AR1 is defined as the region adjacent to the inner peripheral part (an inner peripheral part 24A) of the positive electrode current collector 24. Further, a region AR2 is defined as the region adjacent to the outer peripheral part (an outer peripheral part 24B) of the positive electrode current collector 24. The region AR1 is, for example, a region corresponding to a square (1 mm×1 mm) that is in contact with the bottom surface of the positive electrode current collector 24, with a center-side corner CN1 of the bottom surface as a vertex. The region AR2 is, for example, a region corresponding to a square (1 mm×1 mm) that is in contact with the bottom surface of the positive electrode current collector 24, with an outer-side corner CN2 of the bottom surface as a vertex.

The density is defined by a ratio of an area occupied by the positive electrode active material uncovered part 21C to an area of an entire region, that is, by the following expression:

(area occupied by positive electrode active material uncovered part 21C)/(area of entire region).

In the present embodiment, the density in the region AR1 is higher than the density in the region AR2.

An example of a method of measuring the density will be described. First, the lithium ion battery 1 fabricated by the above-described fabrication method is transversely cut at about half a height thereof and embedded in a resin. Next, the embedded piece of the lithium ion battery 1 is cut at a plane including the central axis of the lithium ion battery 1, and the section is observed with a microscope. Based on a result of the observation, a color image corresponding to each of the regions AR1 and AR2 is acquired with an image data acquisition device. Thereafter, using predetermined image processing software, each color image is binarized to thereby separate the positive electrode active material uncovered part 21C from the others. The density is calculated based on a result of the separation. Note that although the description above has been given with reference to the configuration on the positive electrode 21 side, a similar description applies to the configuration on the negative electrode 22 side.

The present embodiment makes it possible to achieve the following effects, for example.

In the lithium ion battery 1, it is possible to suitably size the diameter of the hole part formed by the active material uncovered part having been bent. That is, by increasing a diameter of an open portion of the hole part 73 communicating with the through hole 26, it is possible to facilitate insertion of the welding rod to be used to weld the negative electrode current collector 25 and the bottom of the battery can 11 to each other. Further, by increasing the diameter of the open portion of the hole part 73 communicating with the through hole 26, it is possible to prevent, during welding, the welding rod from scraping the positive electrode active material uncovered part 21C and causing the separator 23 to become entangled around the welding rod.

Further, the use of the groove forming jig 51 and the flat surface forming jig 61 each having a smaller diameter at the tip than at a base portion helps to prevent the negative electrode active material covered part 22B from becoming exposed during the groove forming process or the flat surface forming process due to damage or peeling, attributable to the jig, of the separator 23 forming the peripheral surface of the through hole 26. Further, the presence of the intermediate parts 54B and 64B allows for making the diameter of the through hole 26 and a diameter (e.g., the first diameter DA) in the vicinity of the open end of the through hole 26 substantially equal. This helps to ensure that the positive electrode active material uncovered part 21C is disposed over the separator 23 located on the inner wind side, thus helping to prevent an end face of the separator 23 in the transverse direction from being exposed and coming into contact with the welding rod. Further, the presence of the intermediate parts 54B and 64B allows for suitably shaping the separator 23 forming the peripheral surface of the through hole 26 into a state of not blocking the through hole 26.

During fabrication of the lithium ion battery, the negative electrode active material can sometimes peel off the negative electrode active material covered part 22B on the beginning side of winding of the electrode wound body 20, i.e., an end side in the longitudinal direction of the positive electrode or the negative electrode located in the innermost wind of the electrode wound body 20, when the edge of a thin flat plate or the like (having a thickness of 0.5 mm, for example) is pressed perpendicularly against each of the end faces 41 and 42, that is, when the process illustrated in FIG. 6B is performed. A possible cause of the peeling is stress generated upon pressing the thin flat plate or the like against the end face 42. The negative electrode active material having peeled off can enter the inside of the electrode wound body 20 and can thereby cause an internal short circuit. According to the present embodiment, the provision of the second negative electrode active material uncovered part 221B and the third negative electrode active material uncovered part 221C helps to prevent the peeling of the negative electrode active material, thereby helping to prevent the occurrence of the internal short circuit. Such an effect is achievable even with a configuration in which only either the second negative electrode active material uncovered part 221B or the third negative electrode active material uncovered part 221C is provided; however, it is preferable that both be provided.

On the end side of the winding of the electrode wound body 20, the negative electrode 22 may have a region of the negative electrode active material uncovered part 22C at a major surface facing away from the positive electrode active material covered part 21B. A reason for this is that even if the negative electrode active material covered part 22B is present at the major surface facing away from the positive electrode active material covered part 21B, its contribution to charging and discharging is considered to be low. The region of the negative electrode active material uncovered part 22C preferably falls within a range from ¾ winds to 5/4 winds, both inclusive, of the electrode wound body 20. In this case, owing to the absence of the negative electrode active material covered part 22B that is low in contribution to charging and discharging, it is possible to make an initial capacity higher with respect to the same volume of the electrode wound body 20.

According to the present embodiment, in the electrode wound body 20, the positive electrode 21 and the negative electrode 22 are laid over each other and wound in such a manner that the positive electrode active material uncovered part 21C and the first negative electrode active material uncovered part 221A face toward opposite directions. Thus, the positive electrode active material uncovered part 21C is localized to the end face 41, and the first negative electrode active material uncovered part 221A is localized to the end face 42 of the electrode wound body 20. The positive electrode active material uncovered part 21C and the first negative electrode active material uncovered part 221A are bent to make the end faces 41 and 42 into flat surfaces. The direction of bending is from the outer edge part of each of the end faces 41 and 42 toward the through hole 26. Portions of the active material uncovered part that are located in adjacent winds in a wound state are bent and overlap with each other. By making the end face 41 into a flat surface, it is possible to achieve better contact between the positive electrode active material uncovered part 21C and the positive electrode current collector 24; and by making the end face 42 into a flat surface, it is possible to achieve better contact between the first negative electrode active material uncovered part 221A and the negative electrode current collector 25. Further, the configuration in which the end faces 41 and 42 are flat surfaces makes it possible for the lithium ion battery 1 to achieve reduced resistance.

It may seem to be possible to make the end faces 41 and 42 into flat surfaces by bending the positive electrode active material uncovered part 21C and the first negative electrode active material uncovered part 221A; however, without any processing in advance of bending, creases or voids (gaps or spaces) can develop in the end faces 41 and 42 upon bending, thus making it difficult for the end faces 41 and 42 to be flat surfaces. Here, “creases” and “voids” are unevenness that can develop in the positive electrode active material uncovered part 21C and the first negative electrode active material uncovered part 221A having been bent, resulting in non-flat portions of the end faces 41 and 42. In the present embodiment, the grooves 43 are formed in advance in radial directions from the through hole 26 on each of the end face 41 side and the end face 42 side. The presence of the grooves 43 helps to prevent the creases and voids from developing, and thereby helps to achieve increased flatness of the end faces 41 and 42. Note that although either the positive electrode active material uncovered part 21C or the first negative electrode active material uncovered part 221A may be bent, it is preferable that both be bent.

In the following, the present disclosure will be further described including with reference to an Example and comparative examples in which the lithium ion batteries 1 fabricated in the above-described manner were used to evaluate a poor shaping rate for each of the positive electrode active material uncovered part 21C and the negative electrode active material uncovered part 22C and a poor welding-rod insertion rate, while varying a magnitude relationship between the first diameter DA and the second diameter DB. Note that the present disclosure is not limited thereto.

In each of all the following Example and comparative examples, a battery size was set to 21700 (21 mm in diameter and 70 mm in height), a length of the negative electrode active material covered part 22B in the width direction was set to 62 mm, and a length of the separator 23 in the width direction was set to 64 mm. The separator 23 was placed to cover all of regions of the positive electrode active material covered part 21B and the negative electrode active material covered part 22B. The length of the positive electrode active material uncovered part 21C in the width direction was set to 7 mm. The number of the grooves 43 was set to eight, and the eight grooves were arranged at substantially equal angular intervals.

A section of the lithium ion battery 1 was observed in the following manner.

The lithium ion battery 1 fabricated by the fabrication method described above was transversely cut at about half the height thereof and embedded in a resin. Next, the embedded piece of the lithium ion battery 1 was cut at a plane including the central axis of the lithium ion battery 1, and the section was observed with a microscope.

As described above, the straight line coupling the points on the bottom surface of the current collector was defined as the reference line DC. A diameter smallest over the distance range of 0.5 to 1.5 mm from the reference line DC toward the inner part of the electrode wound body 20 was measured as the first diameter DA. The value of the first diameter DA was rounded off to one decimal place. Further, a diameter smallest over the distance range of 0 to 0.2 mm from the reference line DC toward the inner part of the electrode wound body 20 was measured as the second diameter DB. The value of the second diameter DB was rounded off to one decimal place.

FIGS. 10, 12, and 13 are diagrams corresponding to Example 1, Comparative example 1, and Comparative example 2, respectively.

### EXAMPLE 1

The lithium ion battery 1 was fabricated through the above-described process. At this time, the respective active material uncovered parts were shaped for the positive electrode and the negative electrode using the pins 54 and 64 to cause the first diameter DA to be 2.8 mm and the second diameter DB to be 3.2 mm when performing the observation of the section, as illustrated in FIG. 10, for both the positive electrode and the negative electrode.

### Comparative Example 1

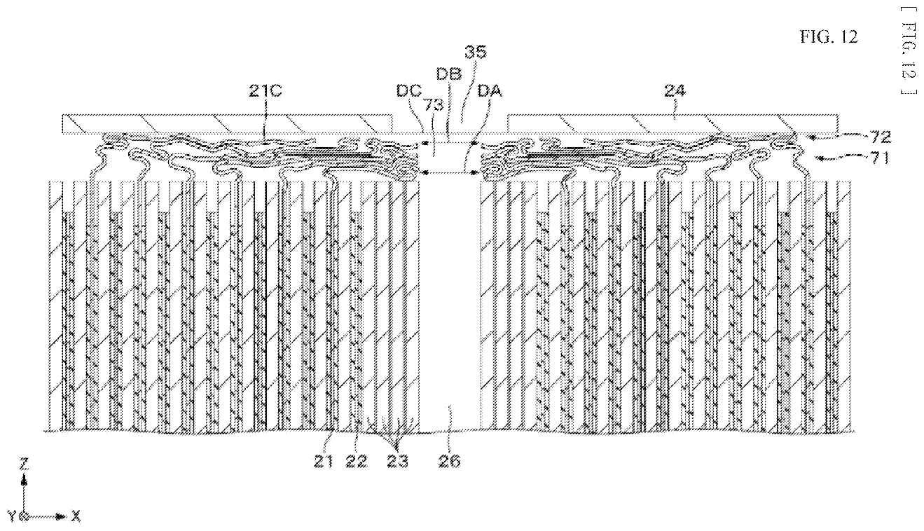

The pins 54 and 64 were replaced with a cylindrical member having a diameter of 3.0 mm. In addition, the respective active material uncovered parts were shaped for the positive electrode and the negative electrode to cause the first diameter DA to be 3.0 mm and the second diameter DB to be the same as the first diameter DA, i.e., 3.0 mm, for both the positive electrode and the negative electrode when performing the observation of the section as illustrated in FIG. 12. The lithium ion battery 1 was fabricated in a manner similar to that in Example 1 except for the above differences.

### Comparative Example 2

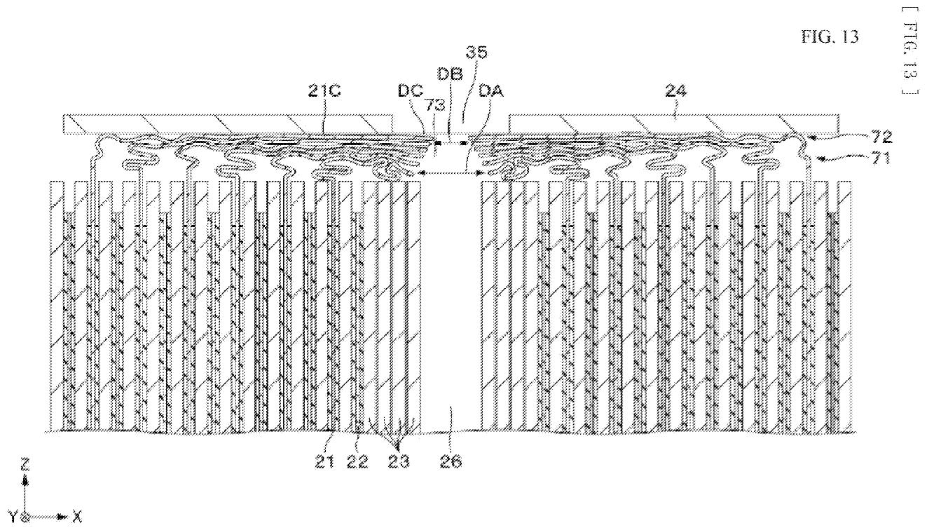

The pins 54 and 64 were replaced with a cylindrical member having a diameter of 2.4 mm. In addition, the respective active material uncovered parts were shaped for the positive electrode and the negative electrode to cause the first diameter DA to be 2.8 mm and the second diameter DB to be 2.4 mm for both the positive electrode and the negative electrode when performing the observation of the section as illustrated in FIG. 13. The lithium ion battery 1 was fabricated in a manner similar to that in Example 1 except for the above differences.

The lithium ion battery 1 was judged defective if it was found that the separator in the innermost wind was deformed and the negative electrode active material in the innermost wind was exposed, by observation of the section after formation of the flat surface. The number of defective lithium ion batteries 1 divided by the total number of the fabricated lithium ion batteries 1 (i.e., the number of samples) was defined as the poor shaping rate for the active material uncovered part.

A welding rod to be used to weld the bottom of the battery can 11 and the negative electrode current collector 25 to each other was inserted into the through hole 26 from the positive electrode side. The welding rod was of a copper-chromium alloy and was 2.2 mm in diameter. The lithium ion battery 1 was judged defective if the hole part 73 was too small in diameter for the welding rod to be inserted therethrough, or if the separator 23 deformed to cause the negative electrode active material covered part 22B to be exposed. The number of defective lithium ion batteries 1 divided by the total number of the fabricated lithium ion batteries 1 was defined as the poor welding-rod insertion rate.

A hundred lithium ion batteries 1 were fabricated for each of respective configurations of Example 1 and Comparative examples 1 and 2, and were subjected to evaluation. The results are given in Table 1 below.

TABLE 1

| | | Relationship | Poor shaping rate [%] for | | Poor |
|---|---|---|---|---|---|
| | | between first | active material uncovered part | | welding-rod |
| | Corresponding | diameter DA and | Positive | Negative | insertion rate |
| | FIG. | second diameter DB | electrode | electrode | [%] |
| Example 1 | FIG. 10 | DA < DB | 0.0 | 0.0 | 0.0 |
| Comparative | FIG. 12 | DA = DB | 5.0 | 8.0 | 0.0 |
| example 1 | | | | | |
| Comparative | FIG. 13 | DA > DB | 0.0 | 0.0 | 4.0 |
| example 2 | | | | | |

In Example 1, the poor shaping rate for the active material uncovered part and the poor welding-rod insertion rate were both 0%. A possible reason for this is that the tips of the pins 54 and 64 were somewhat smaller than the diameter of the through hole 26, which prevented the pins 54 and 64 from dragging the separator 23. Another possible reason is that an opening for the welding rod to be inserted therethrough was large in width, that is, the second diameter DB was large, which allowed for easy insertion of the welding rod and prevented the welding rod from coming into contact with the positive electrode active material uncovered part 21C. A still another possible reason is that the welding rod did not deform the separator 23.

In Comparative example 1, although the poor welding-rod insertion rate was 0%, the poor shaping rate for the active material uncovered part was high for both the positive electrode and the negative electrode (5% for the positive electrode and 8% for the negative electrode). A possible reason for this is that the second diameter DB was small, which caused the separator 23 in an inner wind to become entangled around the welding rod to thereby cause the negative electrode active material covered part 22B to become exposed in the groove forming process or the flat surface forming process.

In Comparative example 2, although the poor shaping rate for the active material uncovered part was 0% for both the positive electrode and the negative electrode, the poor welding-rod insertion rate was as high as 4%. A possible reason for this is that the second opening diameter of the hole part 73 was too small relative to the diameter of the welding rod, which made it difficult to insert the welding rod into the through hole 26.

Based upon the above, the configuration presented in Example 1 is considered to be a preferable configuration of the lithium ion battery 1.

Although one or more embodiments of the present disclosure have been described herein, the contents of the present disclosure are not limited thereto, and various modifications may be made according to an embodiment.

The shape of each of the pins 54 and 64 may be changed as appropriate. For example, the pins may each have a shape without the intermediate part 54B or 64B.

The regions AR1 and AR2 may each have a size other than 1 mm×1 mm.

Although the number of the grooves 43 is eight in Example and the comparative examples, any other number may be chosen. Although the battery size chosen is 21700 (21 mm in diameter and 70 mm in height), the battery size may be 18650 (18 mm in diameter and 65 mm in height) or any other size.

Although the positive electrode current collector 24 and the negative electrode current collector 25 respectively include the fan-shaped parts 31 and 33 each having a fan shape, any other shape may be chosen.

The present technology is applicable to any suitable battery including a lithium ion battery and a battery other than a lithium ion battery, and to any battery having a suitable shape including a cylindrical shape and a suitable shape other than a cylindrical shape, such as a laminated battery, a prismatic battery, a coin-type battery, or a button-type battery. In such a case, the shape of the “end face of the electrode wound body” is not limited to a circular shape, and may be any of other suitable shapes including, without limitation, a rectangular shape, an elliptical shape, and an elongated shape. Further, the present technology is implementable also as a method of manufacturing a battery.

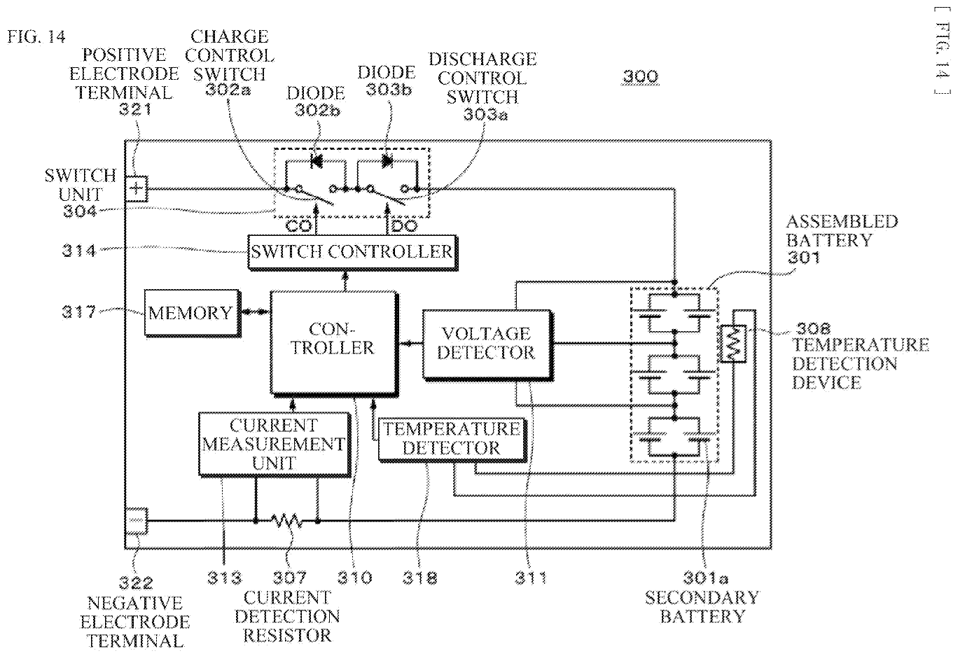

FIG. 14 is a block diagram illustrating a circuit configuration example where the secondary battery according to an embodiment is applied to a battery pack 300. The battery pack 300 includes an assembled battery 301, a switch unit 304, a current detection resistor 307, a temperature detection device 308, and a controller 310. The switch unit 304 includes a charge control switch 302a and a discharge control switch 303a. The controller 310 controls each device. Further, the controller 310 is able to perform charge and discharge control upon abnormal heat generation, and to perform calculation and correction of a remaining capacity of the battery pack 300. The battery pack 300 includes a positive electrode terminal 321 and a negative electrode terminal 322 that are couplable to a charger or electronic equipment for charging and discharging.

The assembled battery 301 includes multiple secondary batteries 301a coupled in series or in parallel. FIG. 14 illustrates an example case in which six secondary batteries 301a are coupled in a two parallel coupling and three series coupling (2P3S) configuration. The secondary battery in an embodiment is applicable to the secondary battery 301a.

A temperature detector 318 is coupled to the temperature detection device 308 (for example, a thermistor). The temperature detector 318 measures a temperature of the assembled battery 301 or the battery pack 300, and supplies the measured temperature to the controller 310. A voltage detector 311 measures a voltage of the assembled battery 301 and a voltage of each of the secondary batteries 301a included therein, performs A/D conversion on the measured voltages, and supplies the converted voltages to the controller 310. A current measurement unit 313 measures currents using the current detection resistor 307, and supplies the measured currents to the controller 310.

A switch controller 314 controls the charge control switch 302a and the discharge control switch 303a of the switch unit 304 based on the voltages and the currents respectively supplied from the voltage detector 311 and the current measurement unit 313. When the voltage of any of the secondary batteries 301a becomes higher than or equal to an overcharge detection voltage or becomes lower than or equal to an overdischarge detection voltage, the switch controller 314 transmits a turn-off control signal to the switch unit 304 to thereby prevent overcharging or overdischarging. The overcharge detection voltage is, for example, 4.20 V±0.05 V. The overdischarge detection voltage is, for example, 2.4 V±0.1 V.

After the charge control switch 302a or the discharge control switch 303a is turned off, charging or discharging is enabled only through a diode 302b or a diode 303b. Semiconductor switches such as MOSFETs are employable as these charge and discharge control switches. Note that although the switch unit 304 is provided on a positive side in FIG. 14, the switch unit 304 may be provided on a negative side.

A memory 317 includes a RAM and a ROM. Numerical values including, for example, battery characteristic values, a full charge capacity, and a remaining capacity calculated by the controller 310 are stored and rewritten therein.

The secondary battery according to an embodiment is mountable on equipment such as electronic equipment, electric transport equipment, or a power storage apparatus, and is usable to supply electric power.

Examples of the electronic equipment include laptop personal computers, smartphones, tablet terminals, personal digital assistants (PDAs) (mobile information terminals), mobile phones, wearable terminals, digital still cameras, electronic books, music players, game machines, hearing aids, electric tools, televisions, lighting equipment, toys, medical equipment, and robots. In addition, for example, electric transport equipment, power storage apparatuses, and electric unmanned aerial vehicles, which will be described later, may also be included in the electronic equipment in a broad sense.

Examples of the electric transport equipment include electric automobiles (including hybrid electric automobiles), electric motorcycles, electric-assisted bicycles, electric buses, electric carts, automated guided vehicles (AGVs), and railway vehicles. Examples of the electric transport equipment further include electric passenger aircrafts and electric unmanned aerial vehicles for transportation. The secondary battery according to an embodiment is used not only as a driving power source for the foregoing electric transport equipment but also as, for example, an auxiliary power source or an energy-regenerative power source therefor.

Examples of the power storage apparatuses include a power storage module for commercial or household use, and a power storage power source for architectural structures including residential houses, buildings, and offices, or for power generation facilities.

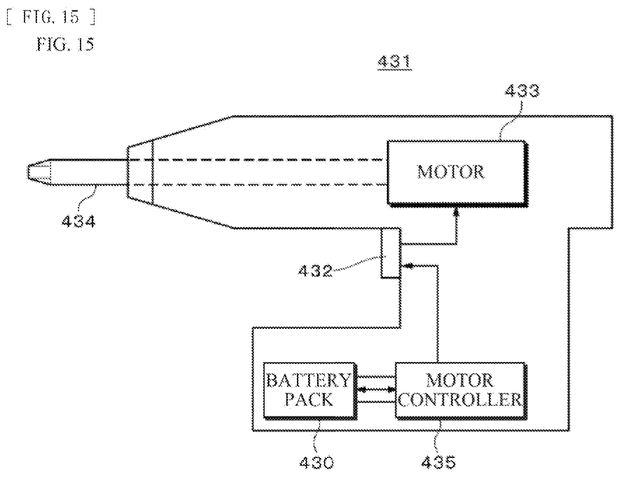

As an example of the electric tools to which the present technology is applicable, an electric screwdriver will be schematically described with reference to FIG. 15. An electric screwdriver 431 includes a motor 433 and a trigger switch 432. The motor 433 transmits rotational power to a shaft 434. The trigger switch 432 is operated by a user. A battery pack 430 and a motor controller 435 are contained in a lower housing of a handle of the electric screwdriver 431. The battery pack 430 is built in or detachably attached to the electric screwdriver 431. The secondary battery in an embodiment is applicable to a battery included in the battery pack 430.

The battery pack 430 and the motor controller 435 may include respective microcomputers (not illustrated) communicable with each other to transmit and receive charge and discharge data on the battery pack 430. The motor controller 435 controls operation of the motor 433, and is able to cut off power supply to the motor 433 under abnormal conditions such as overdischarging.

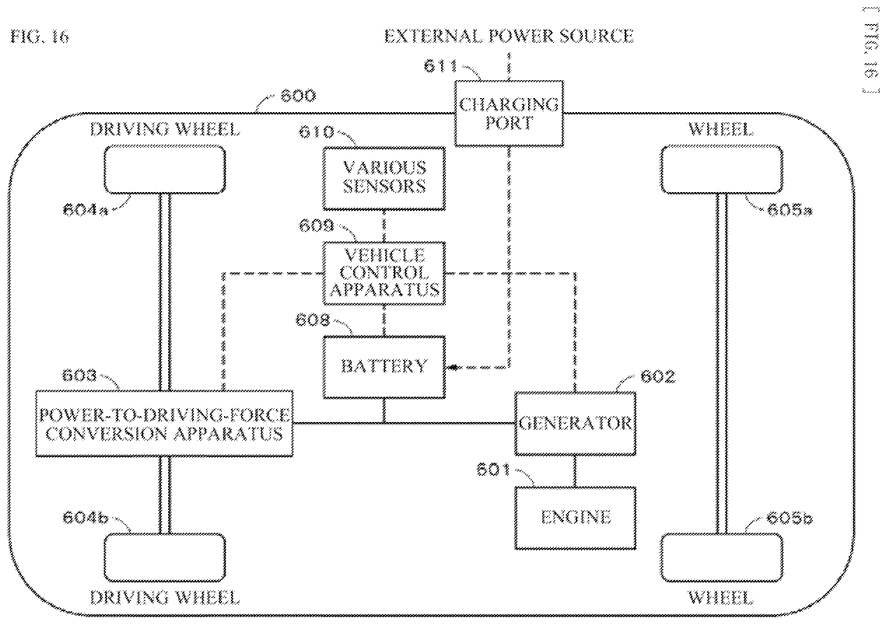

As an example of application of the present technology to a power storage system for electric vehicles, FIG. 16 schematically illustrates a configuration example of a hybrid vehicle (HV) that employs a series hybrid system. The series hybrid system relates to a vehicle that travels with an electric-power-to-driving-force conversion apparatus, using electric power generated by a generator that uses an engine as a power source, or using electric power temporarily stored in a battery.

A hybrid vehicle 600 is equipped with an engine 601, a generator 602, an electric-power-to-driving-force conversion apparatus (a direct-current motor or an alternating-current motor; hereinafter, simply “motor 603”), a driving wheel 604a, a driving wheel 604b, a wheel 605a, a wheel 605b, a battery 608, a vehicle control apparatus 609, various sensors 610, and a charging port 611. The secondary battery according to an embodiment, or a power storage module equipped with a plurality of secondary batteries according to an embodiment is applicable to the battery 608.

The motor 603 operates under the electric power of the battery 608, and a rotational force of the motor 603 is transmitted to the driving wheels 604a and 604b. Electric power generated by the generator 602 using a rotational force generated by the engine 601 is storable in the battery 608. The various sensors 610 control an engine speed via the vehicle control apparatus 609, and control an opening angle of an unillustrated throttle valve.

When the hybrid vehicle 600 is decelerated by an unillustrated brake mechanism, a resistance force at the time of deceleration is applied to the motor 603 as a rotational force, and regenerative electric power generated from the rotational force is stored in the battery 608. In addition, the battery 608 is chargeable by being coupled to an external power source via the charging port 611 of the hybrid vehicle 600. Such an HV vehicle is referred to as a plug-in hybrid vehicle (PHV or PHEV).

Note that the secondary battery according to an embodiment may be applied to a small-sized primary battery and used as a power source of an air pressure sensor system (a tire pressure monitoring system: TPMS) built in the wheels 604 and 605.

Although the series hybrid vehicle has been described above as an example, the present technology is applicable also to a hybrid vehicle of a parallel system in which an engine and a motor are used in combination, or of a combination of the series system and the parallel system. Furthermore, the present technology is applicable to an electric vehicle (EV or BEV) and a fuel cell vehicle (FCV) that travel by means of only a driving motor without using an engine.

### REFERENCE SIGNS LIST

1: lithium ion battery
12: insulator
21: positive electrode
21A: positive electrode foil
21B: positive electrode active material layer
21C: positive electrode active material uncovered part
22: negative electrode
22A: negative electrode foil
22B: negative electrode active material layer
22C: negative electrode active material uncovered part
23: separator
24: positive electrode current collector
25: negative electrode current collector
26: through hole
41, 42: end face
43: groove
221A: first negative electrode active material uncovered part
221B: second negative electrode active material uncovered part
221C: third negative electrode active material uncovered part
DA: first diameter
DB: second diameter
DC: reference line
AR1, AR2: region

It should be understood that various changes and modifications to the embodiments described herein will be apparent to those skilled in the art. Such changes and modifications can be made without departing from the spirit and scope of the present subject matter and without diminishing its intended advantages. It is therefore intended that such changes and modifications be covered by the appended claims.

1. A secondary battery comprising:
an electrode wound body including a positive electrode having a band shape and a negative electrode having a band shape, the positive electrode and the negative electrode being stacked with a separator interposed therebetween;
a positive electrode current collector;
a negative electrode current collector; and
a battery can containing the electrode wound body, the positive electrode current collector, and the negative electrode current collector, wherein
the positive electrode includes, on a positive electrode foil having a band shape, a positive electrode active material covered part covered with a positive electrode active material layer, and a positive electrode active material uncovered part,
the negative electrode includes, on a negative electrode foil having a band shape, a negative electrode active material covered part covered with a negative electrode active material layer, and a negative electrode active material uncovered part extending at least in a longitudinal direction of the negative electrode foil,
the positive electrode active material uncovered part is coupled to the positive electrode current collector at one of end parts of the electrode wound body,
the negative electrode active material uncovered part is coupled to the negative electrode current collector at another of the end parts of the electrode wound body,
the electrode wound body has one or more flat surfaces, in which the positive electrode active material uncovered part, the negative electrode active material uncovered part, or both are bent toward a central axis of the wound structure to form the one or more flat surfaces, and a groove provided in each of the one or more flat surfaces, and
as viewed in a section taken along a plane passing through the central axis,
a hole part provided in a region where one of the positive electrode active material uncovered part or the negative electrode active material uncovered part is bent has a first diameter and a second diameter that are substantially parallel to the stacking direction,
the first diameter is located more toward an inner part of the electrode wound body than the second diameter, and
the hole part increases in diameter substantially continuously from the first diameter to the second diameter.

2. The secondary battery according to claim 1, wherein
where, as viewed in the section, a straight line that couples points on a bottom surface of corresponding one of the positive electrode current collector or the negative electrode current collector coupled to the region where the one of the positive electrode active material uncovered part or the negative electrode active material uncovered part is bent is defined as a reference line,
the first diameter is a diameter that is smallest over a distance range of 0.5 to 1.5 millimeters from the reference line toward the inner part of the electrode wound body, and
the second diameter is a diameter that is smallest over a distance range of 0 to 0.2 millimeters from the reference line toward the inner part of the electrode wound body.

3. The secondary battery according to claim 2, wherein a size, at the reference line, of a region corresponding to a hole of the corresponding one of the positive electrode current collector or the negative electrode current collector is greater than the first diameter and the second diameter.

4. The secondary battery according to claim 2, wherein, as viewed in the section, a density of the one of the positive electrode active material uncovered part or the negative electrode active material uncovered part is higher in a region adjacent to an inner peripheral part of the corresponding one of the positive electrode current collector or the negative electrode current collector than in a region adjacent to an outer peripheral part of the corresponding one of the positive electrode current collector or the negative electrode current collector.

5. The secondary battery according to claim 1, wherein the negative electrode further includes a negative electrode active material uncovered part at an end part in the longitudinal direction on each of a beginning side of winding and an end side of the winding.

6. Electronic equipment comprising the secondary battery according to claim 1.

7. An electric tool comprising the secondary battery according to claim 1.
